(19) United States
(12) Patent Application Publication
(10) Pub. No.: US 2025/0355135 A1
(43) Pub. Date: Nov. 20, 2025

(54) ACOUSTIC PRECIPITATION SENSOR

(71) Applicant: Fraunhofer-Gesellschaft zur Förderung der angewandten Forschung e.V., München (DE)

(72) Inventors: Christoph SLADECZEK, Ilmenau (DE); Sascha GROLLMISCH, Ilmenau (DE); Kevin HOCK, Ilmenau (DE); Julian GÖTZ, Ilmenau (DE)

(21) Appl. No.: 19/292,147

(22) Filed: Aug. 6, 2025

Related U.S. Application Data
(63) Continuation of application No. PCT/EP2024/053254, filed on Feb. 8, 2024.

(30) Foreign Application Priority Data
Feb. 9, 2023 (DE) 10 2023 201 067.4

(51) Int. Cl. G01W 1/14; H02S 20/23; H02S 20/30

(52) U.S. Cl. CPC G01W 1/14; H02S 20/23; H02S 20/30

(57) ABSTRACT

Acoustic precipitation sensor with at least one element that is part of an existing object, wherein the existing structure is arranged such that a precipitation to be captured impacts on the element, wherein the element is configured such that the impacting precipitation generates an acoustic signal, and at least one measuring element that is arranged with respect to the element to capture the acoustic signal; a signal processing unit configured to receive and process a measuring signal generated by the measuring element as a reaction to the acoustic signal so as to determine one or several properties of the precipitation, e.g. in real time, on the basis thereof.

### CROSS-REFERENCES TO RELATED APPLICATIONS

This application is a continuation of copending International Application No. PCT/EP2024/053254, filed Feb. 8, 2024, which is incorporated herein by reference in its entirety, and additionally claims priority from German Application No. 10 2023 201 067.4, filed Feb. 9, 2023, which is incorporated herein by reference in its entirety.

Embodiments of the present invention relate to an acoustic precipitation sensor and a system including one or several acoustic precipitation sensors and a photovoltaics system. In general, an embodiment of the present invention is in the field of precipitation detection. Embodiments concern an acoustic precipitation sensor, such as an acoustic intelligent rain sensor for plate structures, or the use of acoustic sensors and photovoltaic modules or other objects, e.g. containing the plate structures for temporal and spatial high-resolution determination of weather data.

### BACKGROUND OF THE INVENTION

Weather data often includes information about the temperature, wind speed and/or information about precipitation. Among other things, weather data is used for building early warning systems for detecting natural disasters. Precipitation sensors may be used to provide the required database in case of an early detection of thunderstorm-like heavy rain. Further conceivable fields of use of precipitation sensors are research and/or real-time representation of the precipitation.

Conventional precipitation meters (so-called ombrometers) are only capable to determine the precipitation amount, but not its type. To determine the type, a precipitation amount meter (so-called disdrometer) is additionally required. Due to their large installation size, weight, and high energy consumption, both measuring systems are mostly unsuitable to be installed on mobile devices. Furthermore, such measuring systems are unsuitable to the be integrated into flat or encapsulated elements such as PV modules.

Furthermore, there are acoustic rain sensors (e.g. Vaisala RAINCAP® Technology|Vaisala or rain sensor RHD (sommer.at)) comprising a special exposed element such as a semi-sphere as a separate “sensor surface”. However, such a sensor is not compatible with applications such as PV modules. The sensor would have to be attached above the structure and would therefore change the corresponding structure. In PV modules, the corresponding area is covered, leading to losses in the power input.

That is, besides their size and installation space, current precipitation sensors also have disadvantages with respect to their functionality. Thus, there is a need for an improved approach.

In addition to the above-described precipitation sensors, the conventional technology further includes precipitation radar systems, stationary weather stations, precipitation collecting containers for the aggregated determination of the precipitation amount (disdrometer) as well as optical sensors for glass panes, e.g. windshields or roof windows/skylights. However, all of these additional conventional technology variations do not overcome the above-described disadvantages or combinations of the disadvantages.

### SUMMARY

An embodiment may have a method for integrating at least one measuring element into an existing object or an existing structure so as to provide an acoustic precipitation sensor, wherein an element is part of the existing object or the existing structure and is arranged such that a precipitation to be captured impacts on the element, wherein the element is configured such that the impacting precipitation generates an acoustic signal, and wherein the measuring element is arranged with respect to the element to capture the acoustic signal; wherein a signal processing unit is configured to receive and process a measuring signal generated by the measuring element as a reaction to the acoustic signal so as to determine one or several properties of the precipitation, e.g. in real time, on the basis thereof; wherein the signal processing unit comprises an analysis algorithm, wherein the analysis algorithm is configured to adapt the evaluation performed by the signal processing unit to one or several environmental conditions and/or to a mounting position of the measuring element with respect to the element.

Another embodiment may have a system with a plurality of acoustic precipitation sensors arranged so as to be distributed locally, e.g. on different roofs, provided according to the invention, and a unit connected to all precipitation sensors and aggregating the local result of the signal processing unit of the precipitation sensors and/or causing an improvement of an analysis algorithm of one or several of the signal processing units of the precipitation sensor.

Another embodiment may have a photovoltaics system with at least one photovoltaics module as the element and an acoustic precipitation sensor provided according to the invention, at least one measuring element arranged with respect to the element so as to capture the acoustic signal; a signal processing unit configured to receive and process a measuring signal generated by the measuring element as a reaction to the acoustic signal so as to determine, e.g. in real time, one or several properties of the precipitation on the basis thereof.

Embodiments of the present invention provide an acoustic precipitation sensor with at least one element arranged such that a precipitation to be captured impacts (or impinges or strikes) on the element, at least one measuring element as well as a signal processing unit. The element is part of an existing object or an existing structure and is configured such that the impacting precipitation generates an acoustic signal. For example, the acoustic signal may comprise a characteristic oscillation pattern that is characteristic for one or several properties of the precipitation. The measuring element is arranged with respect to the element so as to capture the acoustic signal. The signal processing unit is configured to receive and process a measuring signal generated by the measuring element as a reaction to the acoustic signal so as to determine, e.g. in real time, one or several properties of the precipitation on the basis thereon.

Thus, according to embodiments, what is particular is that the sensor is integrated into existing objects such as solar modules, vehicles, wind shields, . . . with a plate-like structure. An existing plate-shaped structure of an existing object is therefore used as the sensor surface, so to speak, with the object not primarily being developed with the goal of using it as a sensor surface of the acoustic rain sensor, but principally fulfilling another purpose.

According to embodiments, the properties include one or several of the following:
precipitation amount,
precipitation rate,
precipitation type,
drop shape,
drop size, drop size distribution,
drop speed, drop number.

Embodiments of the present invention are based on the finding that by using an acoustic precipitation sensor, the functionalities of an ombrometer and a disdrometer can be unified into one system providing the relevant information to provide conclusions as to the meteorological properties of precipitation events. In this case, it is advantageously possible to provide a classification of the raindrop size and the raindrop number. In advantageous embodiments, the precipitation sensor includes an oscillating (or vibrating) element, such as a shield, a plate, a sensor surface, or other oscillation-capable surfaces, such as a plate-shaped photovoltaic modules as well as a corresponding measuring element, such as one or several microphones and/or oscillation pickups for determining a sound signal, such as air and/or structure-borne sound. The acoustic signal captured by means of one or several sensors is then supplied to signal processing which analyzes the acoustic signal. For example, when combining several sensors (several microphones and/or structure-borne sound pickups or combination of body and airborne sound sensor systems), the measuring signal received or the combined measuring signal received may be compared to one or several signal patterns, e.g. using an algorithm trained by means of machine learning. One or several properties of the precipitation may be assigned to that one or several signal pattern so that, on the basis of the comparison, one or several properties of the precipitation may be determined. In other words, a classification of the precipitation is possible on the basis of the one or several properties.

Embodiments of the present invention have the advantage that by combining an element which the precipitation impacts on and an element for capturing an acoustic signal, precipitation properties such as the drop size distribution, drop number per second/area, etc., could previously not be captured or only with great difficulty. Locally capturing precipitation is possible with low latency and in real time. Furthermore, vertical capturing and evaluation of weather elements is ensured through this. The sensor system can further be manufactured at low costs, with little maintenance efforts, and high energy efficiency. Since one or several sound pickups are just added to the existing components/areas of the apparatus, e.g. in the sense of a body or a housing, the sensor system created provides advantages with respect to the installation space and the installation weight. Surfaces of a photovoltaics system or a building (outer layer of the building) of a mobile object such as an airplane may also be used.

With respect to the signal processing, it is to be noted that, according to embodiments, the signal processing is configured to classify or detect the precipitation on the basis of a time and/or frequency representation or signals, in particular time and/or frequency signals, e.g. a classification of raindrop sizes, number of raindrops in case of precipitation in the liquid state. At this point, it is to be noted that the time/frequency behavior forms a very clear signal pattern so that different properties of the precipitation can be identified and therefore derived very well from these two dimensions. According to embodiments, the signal processing unit includes an analysis algorithm, wherein the analysis algorithm is configured to adapt the evaluation performed by the signal processing unit to one or several environmental conditions and/or to the location of the precipitation sensor and/or to an attachment position of the measuring element with respect to the element. Advantageously, this makes it possible that signal characteristics stemming from factors that are independent of the precipitation can also be considered and therefore do not negatively influence the determination or classification of the precipitation.

With respect to the measuring element, it is to be noted that, according to embodiments, it includes one or several microphones configured to capture a sound signal, such as an airborne sound signal and/or a structure-borne sound signal (microphones rather capture airborne sound; however, airborne sound may also result from structure-borne sound) and/or wherein the measuring element includes one or several oscillation pickups configured to capture an oscillation signal and/or a structure-borne sound signal. Acoustic signals, such as in the audible range or in the inaudible range, and structure-borne sound signals can be detected in a cost-efficient way, easily and reliably. Due to the fact that the sensor system can also be arranged on the inside of the one element (e.g. integration in the module or at the edge), it is advantageously possible to protect the sensor system with respect to environmental influences, such as the precipitation.

According to embodiments, the one element may comprise a special material or a special geometry or special dimensions to generate the acoustic signal such that the one or several properties of the precipitation can be readily determined. On the basis of these influencing factors, a characteristic oscillation pattern is then formed by a corresponding precipitation so that the properties of the corresponding precipitation can be characterized on the basis of this oscillation pattern. Possible shapes are defined by the structure used as oscillating body and that is present anyway, and may include, e.g., a plate-shaped element (flat plate), a dome shape, a key shape, a corrugated sheet shape, a shape of a cavity, the shape of a resonator, a liquid surface, e.g. water, or the shape of at least part of a vehicle body (e.g. a land vehicle, an aircraft, a watercraft, or a spacecraft), etc. Other conceivable implementations are a plate, a disc, glass plates, domes, housing surfaces, outer walls or other oscillation-capable systems. For example, a particular embodiment may be the use of a plate-shaped photovoltaic module as an element (other shapes would also be possible, such as cylindrical PV modules). The use of a roof surface (roof panels or sheet metal) or, in general, a surface as an oscillating structure would also be conceivable. In this case, it is advantageous to use a photovoltaic module or (any) surface thereof as an oscillating element and to create an acoustic precipitation sensor by adding a measuring element and signal processing.

According to embodiments, the existing object or the existing structure that the precipitation sensor uses may include a stationary structure, e.g. a PV module or an outer shell of a building, and/or a mobile structure such as a vehicle. Advantageously, a retrofit option for existing systems, such as a stationary system (e.g. PV systems or skylights) or mobile systems (e.g. a vehicle) is provided by the precipitation sensor described above.

According to embodiments, the element may be configured to be arranged such that the impacting precipitation leaves the element and is led off. For example, an inclined arrangement would be conceivable. In addition, the element may also be heatable so as to be able to defrost precipitation in the form of snow and let it flow away from the element. Thus, the precipitation sensor frees itself autonomously from existing precipitation and is therefore again able to detect new precipitation.

According to embodiments, the element and the measuring element are supported in an oscillation-decoupled way with respect to each other. That is, according to embodiments, an oscillation decoupling element arranged between the element and the measuring element may be provided in the acoustic precipitation sensor. Such oscillation decoupling makes it possible to reduce disturbing influences on to the signal. This is particularly interesting for airborne sound receivers.

According to embodiments, the precipitation sensor may comprise an amplification element configured to amplify the acoustic signal generated by the element. The signal processing unit, according to embodiments, receives the amplified acoustic signal. According to embodiments, the signal processing unit may also comprise means for digitalizing the measuring signal (amplified acoustic signal or acoustic signal) so as to further process them as the digital signals.

As described above, precipitation comes in different forms, e.g. in the solid or liquid state, depending on the outside temperature, pressure, etc. Preferably, the precipitation is in an aggregate state stemming from the atmosphere. The acoustic precipitation sensor is configured to capture solid (frozen) and/or liquid precipitation. According to embodiments, the precipitation sensor may also comprise a plurality of elements arranged so as to be spatially distributed. To this end, one or several measuring elements, e.g. one measuring element per element, may be provided. A distribution of a plurality of acoustic precipitation sensors at several locations, e.g. in the case of several solar cells with an acoustic sensor each on several PV modules or buildings, would also be conceivable. It is advantageous to provide a sensor network that provides high-resolution data for improved weather observation and weather prognosis. Thus, a cost-efficient, low-maintenance and energy-efficient sensor system to provide a close-knit sensor network can be realized. When using a photovoltaic module as an oscillation-capable element, it is possible to provide a close-knit network of the energy infrastructure predestined for the object of sensor systems, which supplies itself with energy and is always available, according to further embodiments. Advantageously, this enables an always-on weather data sensor system for permanently capturing data. Thus, according to embodiments, the acoustic precipitation sensor may be configured to be activated continuously or only at predefined times or for predetermined durations. Furthermore, human, mechanical, and whether-related measuring imprecisions are reduced by high local sensor density and intelligent evaluation. In this respect, according to embodiments, a system with a plurality of locally distributed acoustic precipitation sensors are provided, e.g. arranged on different roofs. Furthermore, the system includes a unit that is connected to all precipitation sensors and that aggregates local results of the signal processing unit of the precipitation sensors and/or causes an improvement of an analysis algorithm of one or several of the signal processing units of the precipitation sensors. A further embodiments provides a photovoltaics system with at least one plate-shaped photovoltaic module, a measuring element, and signal processing. Advantageously, the operation of the measuring element and/or signal processing unit may be realized with energy provided by the photovoltaics system.

Here, it is to be noted that, for photovoltaics systems and other elements, e.g. skylights, according to embodiments, the acoustic precipitation sensor may be advantageously implemented to control these devices in particular to regulate and protect them.

### BRIEF DESCRIPTION OF THE DRAWINGS

Embodiments of the present invention will be detailed subsequently referring to the appended drawings, in which:

FIG. 1 shows a schematic illustration of an acoustic rain sensor according to a base embodiment;

FIG. 2A shows a schematic illustration of a rain sensor using an existing structure with a dome shape (e.g. skylights), with optional features according to expanded embodiments;

FIGS. 2B-C show schematic illustrations to show the principle of acoustic decoupling in the interior of the rain sensor according to embodiments;

FIG. 2D shows a schematic illustration of an acoustic rain sensor according to an extended embodiment;

FIG. 3 shows a schematic illustration of an irrigation system to evaluate a rain sensor according to embodiments;

FIG. 4 shows a schematic diagram to explain the variations of the fall speed of raindrops depending on the distance traveled (K. Wang und H. R. Pruppacher: “Acceleration to terminal velocity of cloud and raindrops”. In: Journal of Applied Meteorology 16.3 (1977), pages 275-280);

FIG. 5 shows a schematic table to describe measuring data of rain sensors;

FIGS. 6A-D show schematic spectrograms as an explanation of the acoustic signals for processing at rain sensors associated with the measuring data of FIG. 5; and

FIGS. 7A-G show schematic illustrations of possible geometries for an element of the rain sensor according to embodiments.

### DETAILED DESCRIPTION OF THE INVENTION

Before embodiments of the present invention are subsequently described on the basis of the drawings, it is to be noted that elements and structures having the same effect are provided with the same reference numerals so that their description can be applied to each other or is interchangeable.

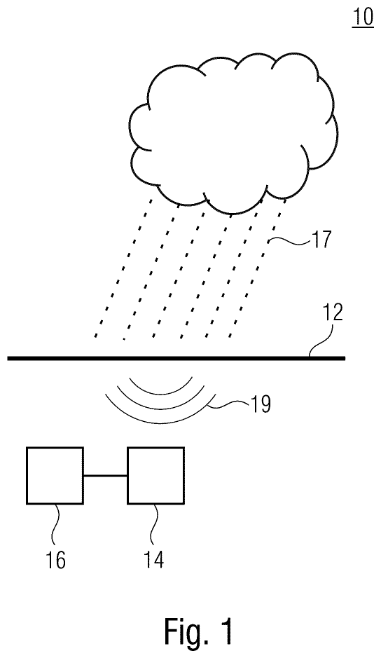

FIG. 1 shows an acoustic rain sensor 10 with the two sensor elements 12 and 14. The element 12 may be an already existing element, such as a pane, glass pane, plate, dome, housing surface, outer wall, body surface, or any other oscillation-capable surface, arranged such that precipitation 17 to be captured impacts on the element 12, wherein the element 12 is configured such that the impacting precipitation 17 generates an acoustic signal 19.

The element 14 is a measuring element, such as a microphone or an oscillation pickup (oscillation pickups may be attached directly on the plate structure, i.e. without spatial distance) arranged with respect to the element 12 to capture the acoustic signal 19. For example, the acoustic signal may be a sound signal, e.g. in the inaudible range (ultrasound, infrasound, etc.), or it may be a structure-borne sound signal. The microphone and/or the oscillation pickup captures this acoustic signal 19 and converts it into a measuring signal. This measuring signal is then forwarded (directly, in an amplified way, or in a preprocessed way) to a signal processing means 16 and is evaluated by the same. Alternatively, the evaluation may also be done externally, e.g. on a server or in the cloud.

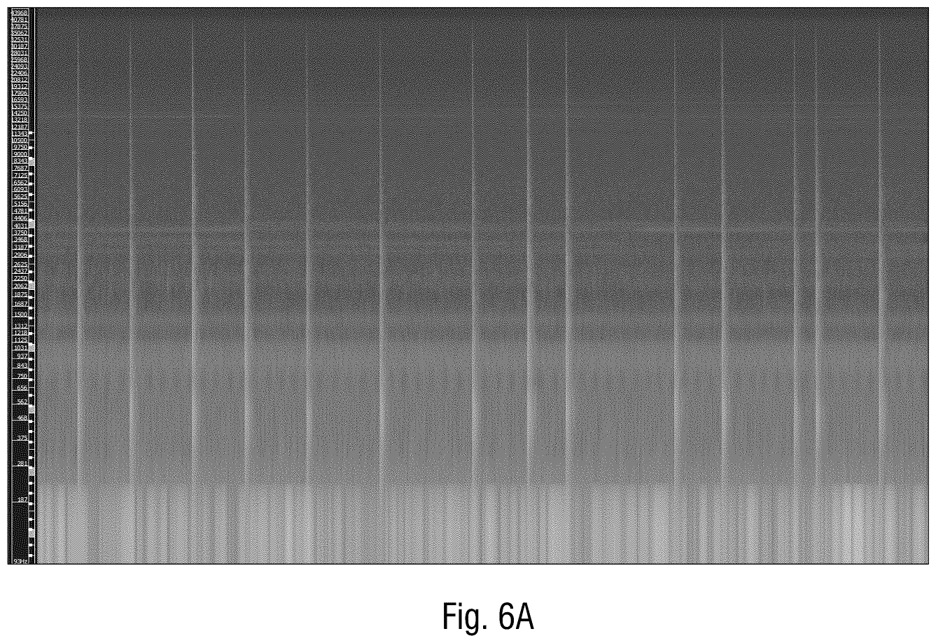

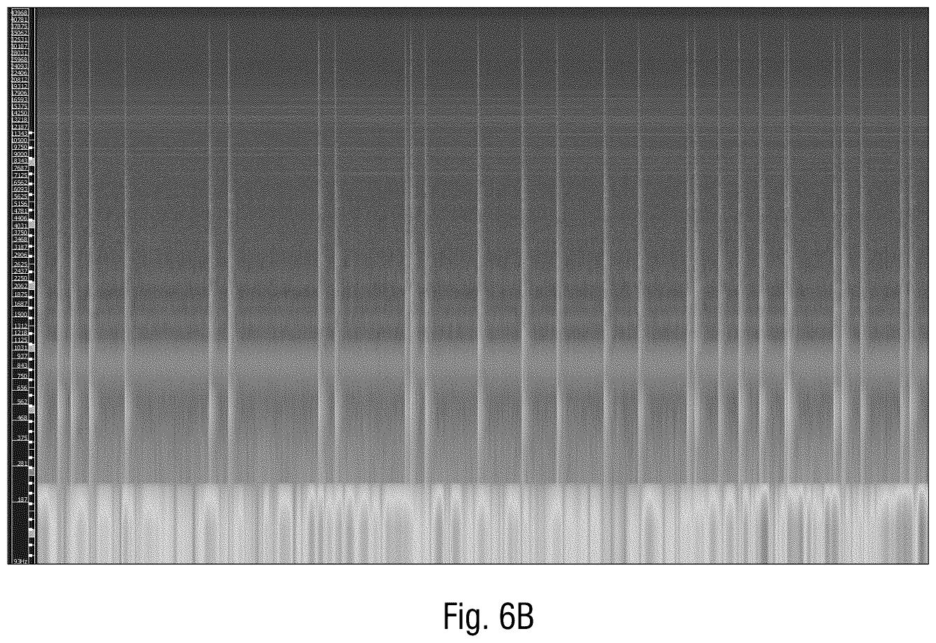

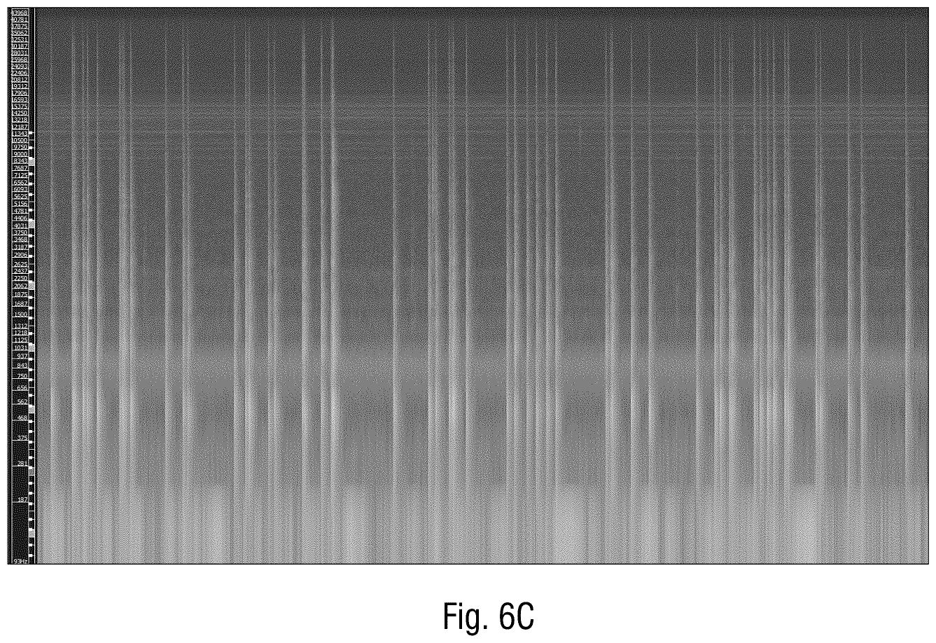

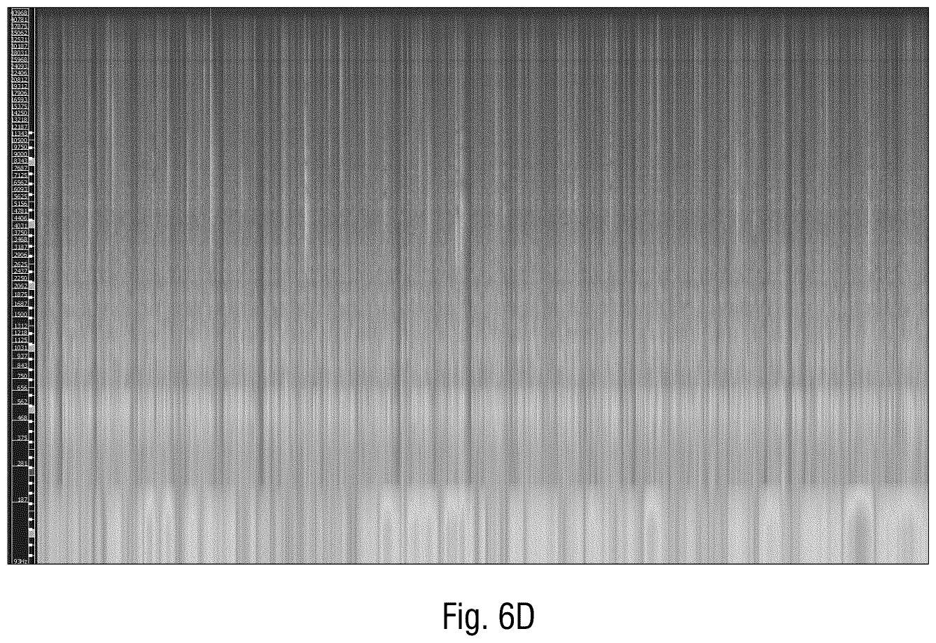

In the evaluation or processing by the unit 16, on the basis of the measuring signal, one or several properties of the precipitation, such as a prior precipitation amount, a precipitation rate, a precipitation type, a drop shape, a drop size, a drop distribution, a drop speed, a drop number, etc. may be determined. According to embodiments, such a determination is possible in real time. According to embodiments, signal processing units may be configured to perform a comparison of the received measuring signal with one or several signal patterns. The one or several signal patterns can be associated with one or several properties. FIGS. 6a-d illustrate a graphically illustrated signal pattern for different precipitation events, i.e. precipitations in different properties.

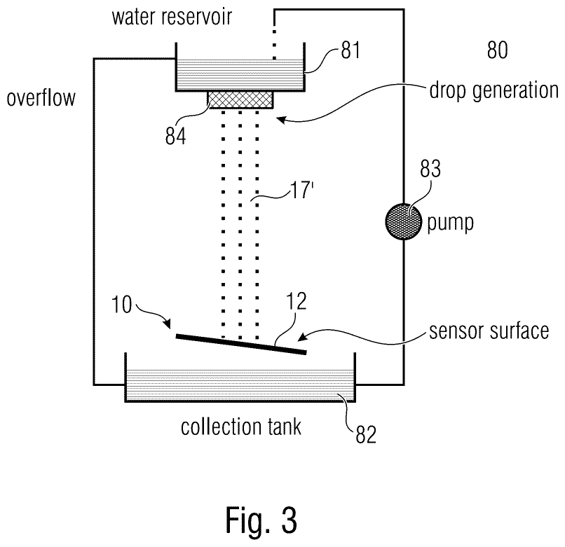

FIGS. 6a-d show different time-frequency diagrams, i.e. spectrograms, that can be associated with different rain events, such as different drop speeds and a different amount of water. According to embodiments, the comparison of the measuring signal to one or several signal patterns may be done using an AI algorithm. In this respect, the signal processing for evaluation comprises an algorithm trained by means of machine learning. On the basis of this comparison, the one or several properties may be determined, or the precipitation may be classified in general. For the classification, according to embodiments, one or several properties of the precipitation may be combined to classes and may be assigned to characteristic signal patterns. To determine such a database, advantageously, machine learning may be used. Determining the database as well as testing the precipitation sensor 10 is possible by means of an irrigation system 80, as shown in FIG. 3.

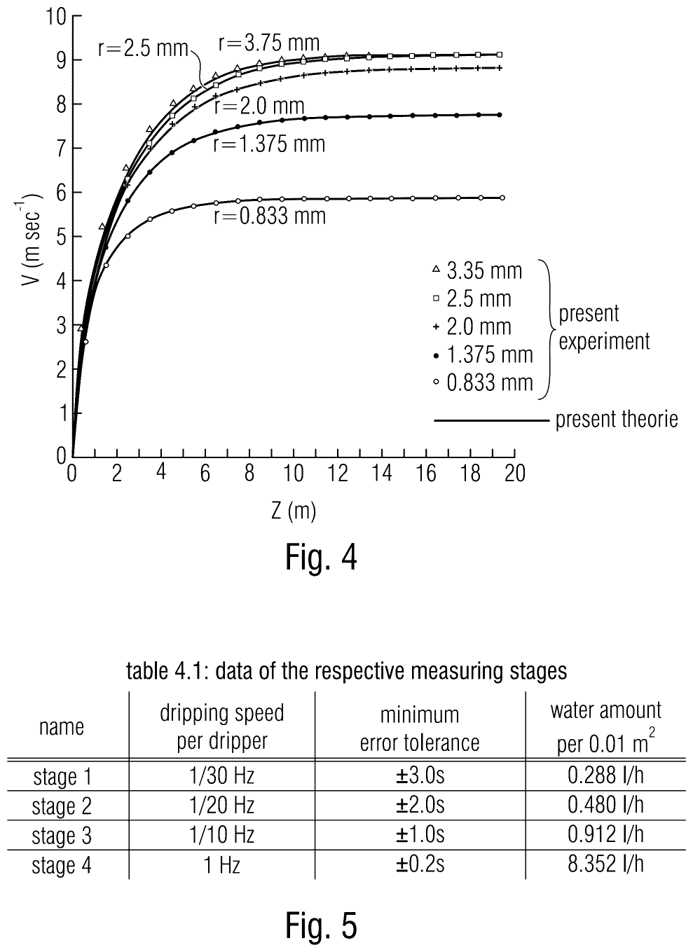

The irrigation system 80 according to FIG. 3 includes a water reservoir 81 simulating a precipitation 17′. To this end, water is pumped from the collection basin 82 into the water reservoir 81 by means of a pump. The water in the reservoir 81 may generate different drop shapes of the precipitation 17′ by using a drop generator 84. There may also be an overflow. The sensor 10, or the surface of the sensor 12, is provided between the drop generator 84, or the water reservoir 81, and the collection basin 82. This apparatus 80 can show that there are differences in the acoustic characteristics of different rain scenarios and that they can be classified with the help of the developed precipitation sensor 10. The water reservoir 81 feeds the drop generator 84. Generation consists of several drops 17′. They may be used to set the drop speed (i.e. the drop number per time unit) or the drop number or drop size according to the respective precipitation scenarios generated. The water drop 17′ fall onto the sensor surface 12 and there generate an acoustic signal by impacting on the same. Afterwards, water flowing off is caught by means of a rain gutter and is guided into the collection basin 82. Thus, interfering noise by water dripping off the edge of the sensor surface is avoided. Since the generation of drops is based on the principle of water gravity, a consistently high water column is created in the water reservoir 81 by the pump 83. To this end, the pump 83 continuously pumps water from the collection basin 82 into the water reservoir 81. The water excess generated there may be compensated by means of the overflow that leads the excess water back into the collection basin 82. A collection tube between the overflow and the collection basin is not guided perpendicularly, but so as to be spiral-shaped. This results in a reduced flow speed, which is why flow sounds may be reduced. FIG. 4 shows the variation of the fall speed of raindrops depending on the distance traveled (K. Wang und H. R. Pruppacher: “Acceleration to terminal velocity of cloud and raindrops”. In: Journal of Applied Meteorology 16.3 (1977), pages 275-280)). This highlights that the length of the fall path of the drops is an important factor. The same is determined by the distance between the sensor surface 12 and the drop generator 84. A minimum fall path of 2.5 meters was defined. As can be gathered from FIG. 4, this approximately corresponds to the path that an average raindrop (diameter of more than 0.5 mm) requires to almost reach its terminal velocity of approximately 5.8 meters per second.

To further explain the results, the following definitions are provided: in meteorology, precipitation is defined as the release of water from the atmosphere. This can occur in a solid and/or liquid state and can be observed or measured on the ground. A distinction is also made between different types of precipitation. There is falling, swirling, deposited and settled precipitation. Falling precipitation is caused by the release of water from clouds and has a liquid or solid form. There are basically three causes for its formation: condensation, sublimation or collision of cloud particles. Falling precipitation includes rain, ice rain, snow, sleet, or hail.

Rain is defined as precipitation in its liquid form. The diameter of the raindrops is between 0.5 to 5 mm [source: Deutscher Wetterdienst]. During showers, diameters of up to 6 mm can be reached [source: Deutscher Wetterdienst]. Obviously, larger drops are also possible.

To capture the sound or the oscillation of the noise that the drops generate when impacting on the impact surface of the precipitation sensor, the measuring structure described in the following was used. The same consists of two measuring microphones from Microtech Gefell, a preamplifier 12AQ by GRAS, a measuring interface by HEIM (consisting of the modules PWAC, DIC6B and LMF2FE), and a laptop with the associated recording software Sirecord.

A measuring microphone consists of a microphone capsule of the type MKS221 and a microphone amplifier of the type MV212. The two microphones were each hung at the rear edge and the left edge at a height of 1 m with a distance of 50 cm to the impact center and in a plane with the inclined surface. This corresponds to an effective distance of v 1.25 meters.

On the basis thereof, measuring data, such as shown in FIG. 5, may be generated. FIG. 5 shows a table with four precipitation intensities (levels 1-4). Each precipitation intensity is defined by means of a drop speed per dripper and an amount of water per 0.01 m². According to embodiments, the sensor system may differentiate between the four levels or between even more levels (higher resolution of the precipitation intensities) or less levels.

Prior to each recording of measuring data, calibration of the measuring microphones by means of the recording software takes place at 1000 kHz, 94 dB (SPL) and an amplification factor of 20 dB set at the preamplifier. Recording is done with a sample rate of 96 KHz. For further processing, the files were converted into the .wav format. A first audio channel is assigned to the microphone at the rear side and the second channel is assigned to the microphone at the left side of the impact surface. At each level, the drop speed was set by hand. To this end, the temporal distance between two drops in each dripper was measured and was corrected until it was within the error tolerance. In addition, the drop speed was defined individually for each level. Eleven hours of audio data were recorded per setting. In the context of the internal research project, they should be used as a training data set for a machine based learning algorithm. To generate and annotate the data sets, e.g. by irrigation systems with defined flow rate and controlled drop size, cf. FIG. 3, an image-based capturing of precipitation events may alternatively be used as a reference with respect to the acoustic capturing (expose the defined plane structure to real precipitation results and capture the precipitation with standardized methods (e.g. by means of reference measuring technique and weather measuring stations)).

To evaluate the results, a spectrogram was created (FIGS. 6a-d) for each measuring level (FIG. 5). Each of them show the temporal progression of the logarithmically illustrated frequency spectrum in a range of 0 to 40 KHz and across a duration of 20 seconds. As can be seen in the individual spectrograms, a water drop impacting on the impact surface of the precipitation sensor results in a short-term amplitude maximum extending across the entire frequency range observed. This characteristic feature makes it possible to precisely identify the individual impacting drops. Different drop sizes differ in their general occurrence in the spectrogram. Here, e.g. features of the temporal decay behavior, the maximum frequency and the maximum sound amplitude.

The following can be shown with respect to the spectrogram of level 1, representing the lowest drop speed (FIG. 6a). The maximums occurring, compared to the other levels, with a large temporal distance clearly represent the slow dripping of the irrigation system. The frequency band visible in the lower frequency range (0-260 Hz) tends to arise from the noise of the measuring structure and can be found in the other three spectrograms as well. Comparing the spectrograms of levels 1-4, a correlation between the increasing drop speed and the increasing number of amplitude maximums can be observed.

In summary, with the help of the precipitation sensor, it is possible to distinguish between different rain intensities due to the information contained in the spectrograms. Thus, the rain sensor could fulfill the requirement mentioned in the object of the invention so as to enable conclusions as to the properties of different precipitation events. In addition, in light of the results, it can be assumed that it should be possible in principle to be able to analyze and classify further precipitation types, such as snow, with this approach.

In addition, it would be conceivable to vary different shapes (e.g. dome-shaped) and materials (e.g. plastic or aluminum) with respect to the sensor surface since individual implementations work particularly well for special precipitation types.

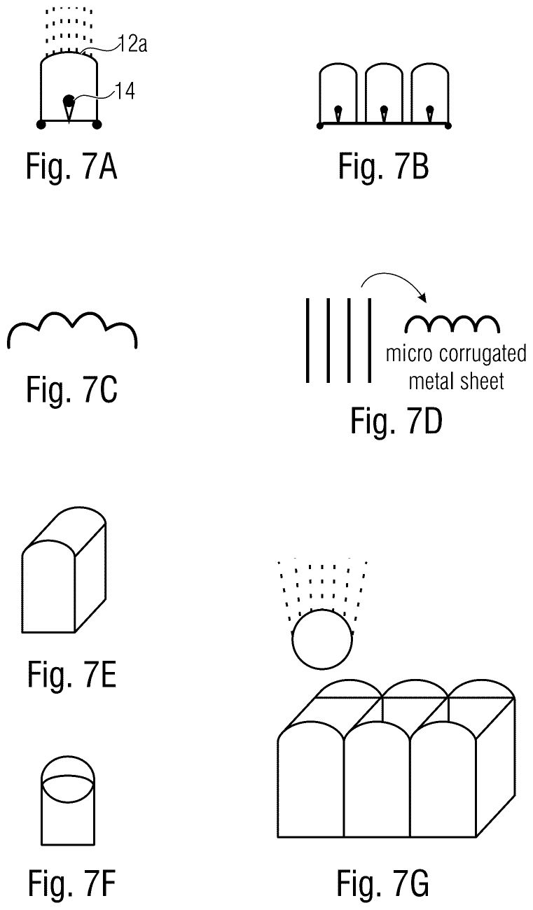

With reference to FIGS. 7a-g, different surface structures or geometries of the element which the precipitation impacts on are discussed with the advantages and disadvantages, as well as preferred applications.

FIG. 7a shows a cavity resonator with a dome-shaped surface 12a. A cavity is provided on the inside of the cavity resonator. This cavity has an influence on the acoustic signal when recording by means of a microphone 14. Reflections of different frequencies depend on the spatial geometry. In this respect, this geometry may be used to achieve an acoustic optimization, e.g. by pre-filtering the frequency spectrum. A further dependency factor is the material thickness, which has an influence on the sensitivity. In order to account for this, different dome shapes may be used simultaneously, as shown in FIG. 7b.

The embodiments of FIG. 7a and the embodiments of FIG. 7b have a bulged surface 12b, advantageously enabling that the impacting precipitation can flow off from the sides. Thus, the influence of standing water with respect to the frequency spectrum can be reduced. The shape also has an influence on interfering signals, such as on the basis of wind or splash water, which overlap the acoustic signal to be evaluated. According to embodiments, the surface may also be coated in order to prevent water from standing there.

Hydrophobic coating and/or a lotus effect would be conceivable to increase precipitation dissipation. The sensitivity can be increased especially for low precipitation that is hard to detect. FIG. 7g shows a further development of FIG. 7a., i.e. a cavity resonator with three domes. The following is a description of the cavity resonator: the plate of the resonator represents an oscillating element, while the raindrop represents the generator. By using a resonator, an amplification is provided. The resonance space has an influence on the frequency behavior. Frequency portions closer to the natural resonances are let through in a less weakened way than those that are further spaced apart from the natural frequency. In other words, a mechanical filter is provided. For example, by selective adaption of the resonances, a resonance amplification may be achieved.

According to embodiments, adapting the resonance is conceivable via different materials and/or thicknesses and/or shapes. For example, different materials are used instead of or together with the different thicknesses so as to form different acoustic properties. Due to the different acoustic properties, different characteristic acoustic curves are formed. Reviewing those together allows drawing conclusions as to the drop size and amount. For example, it is to be noted that thinner membrane thicknesses are more suited for analyzing weak rain than thicker ones, while thicker membrane thicknesses are more suited for analyzing heavy rain, since they have higher attenuations and a lower sensitivity and/or cause filtering of certain frequencies.

Overall, it is to be noted that a high sensitivity would be desirable in case of weather events with low intensity, while the high sensitivity could be of disadvantage in the case of heavy rain. According to embodiments, it would also be conceivable to use different sensors or sensor implementations in combination so as to be able to selectively determine different rain events. Thus, the embodiment of FIG. 7b with several membranes, here three, e.g., with different material thicknesses and/or different dimensions, represents an advantageous trade-off to detect different weather events with different sensitivities.

According to embodiments, the surface may also comprise a fluid, such as water, changing the oscillation behavior. A water surface, e.g. of a pool, may also be used directly. I.e. instead of a firm surface, according to embodiments, a fluid may be used. This causes the effect of volume pulsation. In this case, a bubble radius of e.g. 0.15 mm to 15 cm is created, which therefore generates a tonality between 20 Hz and 20.000 Hz. The noise depends on the surface tension of the water. Depending thereon, certain drop sizes (volume) and certain fall heights with a certain kinetic energy may be detected in an efficient way. The water surface as an oscillating membrane transfers sound very effectively to the air. The filling height, or water surface membrane, has an influence on secondary effects, such as forming of daughter bubbles on the basis of the main bubble, which may lead to a falsification of the frequency spectrum. When using such fluidic membranes, it is an advantage that the energy of secondary drops usually is not sufficient to generate a typical sound so that interfering noise in the form of splash water can be eliminated by using a fluid membrane.

Furthermore, it is to be noted that the impact angle and therefore also the shape has a significant influence on the behavior. Thus, advantageously, one or several impact angles may be determined according to embodiments, e.g. by a corrugated sheet metal or the like. FIGS. 7c and d show the use of wave-shaped surfaces, such as a micro corrugated metal sheet (cf. FIG. 7d).

The dome shapes shown in FIGS. 7a and 7b may also comprise a one-dimensional dome (cubic base-shape) as illustrated in FIG. 7e, or also a three-dimensional dome as illustrated in FIG. 7f (cylindrical base-shape). The embodiment of FIG. 7e is easier to manufacture, while the embodiment of FIG. 7f provides similar impact angles in all directions.

Thus, in summary, the surface properties and object properties, such as the geometrical shape, surface size, material type, thickness, thickness progression (in the sense of a varying thickness), coating, etc., have an influence on the frequency spectrum and especially the amplitude so that filter effects and/or amplification effects may be achieved. The base-shape (round, square, . . . ) or the size may also have an influence. Due to these factors, interfering factors, such as splash water or wind may also be reduced. Especially in case of fluidic membranes, e.g., a hydrophone is used, while conventional microphones would also be conceivable (embodiment: fluid film on skylight, observing the signal transferred from the water film to the skylight with a microphone or structure-borne sound receiver). Typically, the sound in the water is captured as a near-field signal. In the sea, it has been shown that the peak is typically over 13.5 kHz or over 12 kHz or over 14 kHz or over 15 kHz. In contrast, drops on a firm membrane have a peak of approximately 7 kHz (range of 4.5 to 9.5 kHz or 6 to 8 KHz or 6.6 to 7.4 kHz). Thus, the frequency range to be evaluated strongly depends on the materials used and the membrane type.

All of these influencing factors may be considered in signal processing. Depending on the oscillation-capable element used, signal processing may carry out a training or calibration process (e.g. automatically). Also, machine learning of the evaluation algorithm may be enhanced during operation.

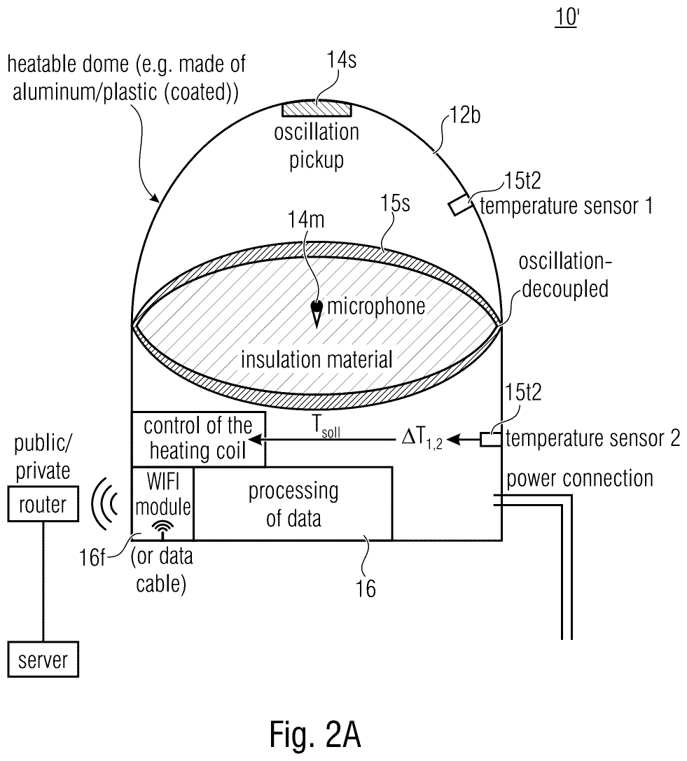

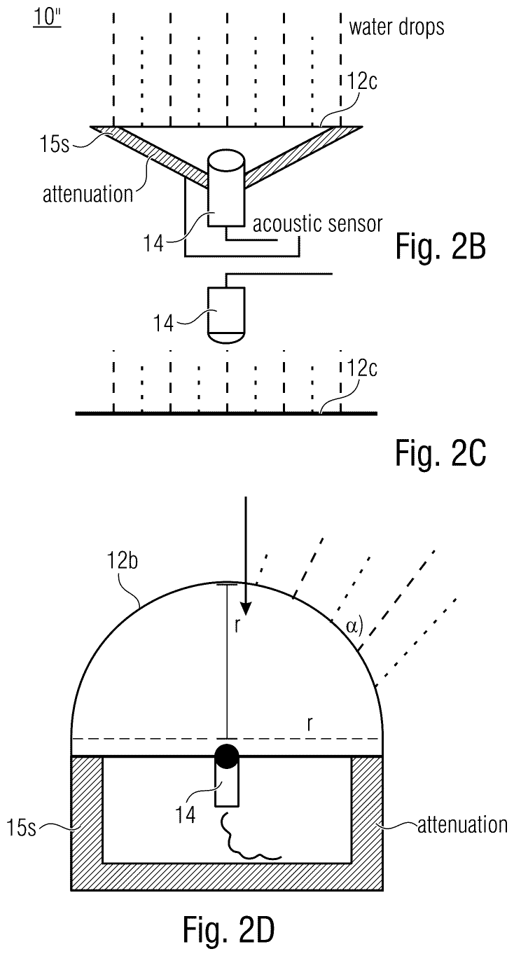

FIG. 2a shows a sensor 10′, e.g., with a dome 12b, e.g. a dome of a skylight, as an oscillating element. For example, this dome may consist of glass, aluminum, plastic, or a coated material, and is curved on both sides.

According to embodiments, a microphone 14m is arranged as a signal pickup on the inside of the dome, supported by an oscillation decoupling element 15s in an oscillation-decoupled way. Insulation material, such as insulation wool, may be provided within the oscillation decoupling element 15s, or in general around the microphone 14m. The oscillation decoupling element as well as the insulation material have an effect of preventing interfering noise. Additionally or alternatively, an oscillation pickup 14s may also be provided as a measuring signal pickup. For example, the same is directly mechanically coupled to the element 12b. As an alternative to the microphone, a so-called hydrophone may be used. A possible field of use would be the arrangement of FIG. 2c, for example.

Further sensors, such as the temperature sensors 15t1 and 15t2, may be provided in addition to the two sensors discussed above. 15t1 is located at the dome and therefore measures the outside temperature, while 15t2 is located within the dome. On the basis of the temperatures, e.g. on the basis of the temperature difference between the two sensor signals 15t1 and 15t2, a heating coil may be controlled to so as to heat the dome.

According to embodiments, such sensor values, e.g. temperature information or other sensor values, may be used to evaluate, e.g. to adapt, the signal processing. This one or several signals may be used as a further input signal when evaluating by means of AI.

In addition, the acoustic sensor illustrated herein also comprises a data processing apparatus 16, e.g., the same is supplied with power from the outside and may transfer the sensor data towards the outside by means of a data cable or also by means of a Wi-Fi module or a radio module 16f. Encryption with a public and/or private key to the receiver or server would also be possible.

FIG. 2b shows a further shape of a precipitation sensor 10″. Here, an oscillation-capable element 12c is illustrated, e.g., in a planar shape. An acoustic sensor 14 is connected to the membrane 12c via attenuation elements 15s. As illustrated herein, the sensor 14 is arranged below the membrane 12c, offering good moisture protection. With respect to the plate shape of the membrane 12c, it is to be noted that lateral drops are hard to be detected. The dome shape illustrated in FIGS. 2a and 2d, even though the same is more complex, offers good properties for moisture protection as well as good detectability of lateral drops.

FIG. 2d illustrates a simplification of the embodiment of FIG. 2a. The dome-shaped membrane 12b provides a cavity, further enclosed by an attenuation element 15s. The sound pickup 14 is located on the inside, e.g., at the center. For example, the dome 12b has a constant radius across 180 degrees so that lateral rain can be detected and lateral protection against wind is ensured.

FIG. 2c shows a further possible arrangement of the membrane 12c in combination with a measuring signal pickup 14, arranged above the same and determining the acoustic signals when reflected from the surface of the membrane 12c. This structure is cost-efficient and simple, and can be used as a retrofit. A plate-shaped structure has a disadvantage, especially in a horizontal arrangement, in that impacts due to the due to splashes of the impacting drops are possibly detected as well. It is advantageous that, due to a flat membrane 12c, good sensitivity may be achieved, since the stiffness is lower. In case of an oblique membrane 12c, runoff of the water may be ensured. At this point, it is to be noted that, according to embodiments, the membrane may also be configured in several parts so that several elements oscillate. One or several sound pickups per membrane, or per arrangement, including several membrane elements would be conceivable. Especially an angled surface, e.g. 10 degrees, enables that impacting water be removed quickly, and that dirt having an influence on the acoustic signal mostly be removed by means of self-cleaning. The lotus effect or a hydrophobic coating support these two effects, according to further embodiments. In this case, an optimization for using the Cassie-Baxter state applies. Wetting of solid body surfaces is influenced by the surface structure, or the surface roughness. In the Cassie state, the drop is located on the peaks of the surface structure, while air may be enclosed between the drop and the surface. This effect may be selectively used to design the surface such that it has hydrophobic properties. The Wenzel state describes the effect contrary to the Cassie state. In the Wenzel state, the water drop “meshes” with the rough surface structure and therefore, creates a hydrophilic effect (source: Christian Dorrer and Jürgen Ruhe. “Condensation and Wetting Transitions on Microstructured Ultrahydrophobic Surfaces”, In: Langmuir 23.7 (2007), pages 3820-3824).

The surface size has an influence on the signal and in particular on the signal strength. If the surface is too small, an amplification by means of an amplifier may be used. Preferably, a linear amplification across the entire frequency response is desired. According to embodiments, a non-linear amplification or filtering to highlight different frequency portions may also be used. Due to such filtering, an optimization with respect to certain precipitation events, such as drop sizes and therefore also selectivity, may be achieved. That is, according to embodiments, an adaptation to certain precipitation results may be possible by using filters and/or amplifiers and/or by selecting the resonance frequency of the oscillating element. Thus, it would also be conceivable to optimize the acoustic precipitation sensor particularly for weak precipitation events with low amounts of water and/or low impact speeds and/or small drop sizes.

In summary, it is to be noted that due to different factors, such as the material surfaces of the oscillating element, the surface shape of the oscillating element, the surface coating and/or the selective use of a surface film due to water, an optimization of the sensitivity or selective sensitivity may be achieved. This may also or additionally be achieved by means of technical means, such as filters or amplification elements. The shape and/or inclination of the oscillating element also has an influence, since it facilitates or prevents runoff of the water.

The application also has an influence on the geometry, quality, and shape of the precipitation sensor. Subsequently, two specific embodiments are described, i.e. the rain sensor on as used under laboratory conditions the one hand, and a rain sensor being integrated into a photovoltaic module on the other hand.

On the basis of the above-described irrigation system, the rain sensor 10′ of FIG. 3 is described, which is used to determine learning data. With the help of the irrigation system of FIG. 3, different drop combinations are used to determine acoustic signals associated with the drop combinations and precipitation results.

The acoustic signals created here are captured as a frequency and amplitude spectrum. The drop size, length and kinetic energy of the water drops have an influence on the signal, that can be simulated as follows.

| Variable | Variable size | Effect/measuring goal/target |
|---|---|---|
| Distance | e.g. three | Influence on the kinetic energy, drop |
| between drip | different distances | size (divisional of the large drops |
| end and | between the drop | starting from a certain speed) |
| sensor surface | generator and the | |
| | sensor surface | |
| Number of | A total number of | Simulation of different rain scenarios: |
| opened drip | drip ends, number | few/many (temporally and spatially) |
| ends and | of drips are | small/large water drops |
| opening degree | opened, and | |
| | opening degree | |
| Arrangement of | e.g. two | Difference between measurement of |
| the two | measuring | the impact sound of the water drops |
| measuring | microphones | under and above the sensor surface or |
| microphones | | laterally |
| Structure of | geometry and | Cavity and resonator |
| the microphone | material | |
| box | | |
| Sensor surface: | | |
| Material | e.g. aluminum, | Is there a useful difference in the |
| | plastic | spectrum of the two different |
| | | materials? Is it easier to classify |
| | | the drops with one material? |
| Thickness | different material | Does thinner material or a |
| | thicknesses | combination of different thicknesses |
| | | possibly simplify the classification |
| | | of smaller/fewer water drops? |
| Geometry | dome-shaped | Does the geometry have a measurable |
| | (bowl), | influence on the spectrum? Are |
| | corrugated, flat | there certain shapes that make it |
| | plate, angle of | easier to classify the drops? Which |
| | inclination | influence do water puddles have with |
| | | respect to the sensor surface (changes |
| | | of the sound emission of the |
| | | impacting water drops). Can water |
| | | puddles be avoided by adapting the |
| | | geometrical shape? Can water drops |
| | | be mitigated/avoided? |
| Surface size | Selection of a | Is there a minimum area required to |
| | square or other | balance the stochastic distribution of |
| | base shape that | the various raindrops, i.e., the |
| | has to cover the | average value? |
| | object | |
| | (specification to | |
| | a certain area is | |
| | difficult due to | |
| | different | |
| | geometries) | |

This enables a classification of the drops into drop size (distribution in different diameter ranges), drop number of the different drop diameters and/or impact energy/speed. It has been shown that the distance between the drip end and the sensor surface has a significant influence, as already described on the basis of FIG. 4. Background for this is that the drop height has an influence on the end velocity.

On the basis of this finding, a plate-shaped sensor may be used in a photovoltaics system. The photovoltaics system, or the plate-shaped surface, represents the oscillation-capable element. Due to its geometric shape as a plate structure, a PV module is susceptible to forming oscillation patterns that could be caused by rain or wind. If these patterns appropriately form, it is conceivable that a totally novel, self-supplying and always available system for capturing weather data may be realized due to a (vibro) acoustic sensor in combination with an intelligent signal analysis algorithm. If valid data evaluation can be carried out, there is the vision of an aggregation of multiple units for implementing a far-reaching network that is for the first time able to capture high-resolution weather data in real time.

Extreme weather is seen as the greatest risk with respect to operating photovoltaics systems and in the worst case may lead to spontaneous failures. To keep the risk for energy networks and network operators as low as possible, permanent weather monitoring is necessary to secure energy security.

In addition, the captured weather data would contribute to improving meteorological weather modeling and prognosis. Precision agriculture could profit by optimizing yields due to resource-efficient irrigation, with respect to a resilient water supply. In terms of civil protection and disaster control, more accurate spatial and temporal weather data can be used not only to protect critical infrastructure, but also to support emergency services in a more targeted manner, thereby saving lives and property even more effectively in the event of an emergency. According to embodiments, an aggregation of multiple local units is possible to implement a more extensive network.

The approach according to embodiments is based on the use of inexpensive, energy-efficient acoustic sensors on solar panels in the completely new field of application of determining high-resolution weather data to strengthen energy serenity and to improve understanding of climate change. The use in photovoltaics systems is particularly advantageous since photovoltaics systems are expected to expand rapidly in the coming years, enabling the establishment of a very good sensor network for weather measurements. Furthermore, photovoltaics systems may also directly use the sensor information, e.g. to forecast the expected amount of energy.

Another embodiment relates to a mobile apparatus with a corresponding sensor. As described above, the sensor is advantageous in terms of installation space and installation weight, so that even small, lightweight apparatuses can use such sensors for weather data determination. A multitude of objects have free surfaces that can be used as an oscillation-capable element so that the weather sensor may be completed by adding a sound pickup. The material of the surfaces, like the surface quality, etc. have an influence that has to be taken into account.

Since surfaces often vary, precipitation data can be determined or general classification can be carried out using different training data, according to embodiments. The training data is preferably determined using a sensor or a comparable sensor and is assigned to different precipitation events or precipitation characteristics. This leads to an improvement of meteorological weather modeling and prognosis due to the captured weather data. It is to be noted that captured measuring data can be used to measure other parameters due to correlation, such as matter pollution (compensation nuclei) or cloud height, of/on wind turbines.

Classification: As explained above, different properties of precipitation, such as the total number of raindrops, the precipitation rate, etc., can be detected. The kinetic energy, i.e., the precipitation velocity and/or drop size, influences the amplitude of the measuring signal. The drop diameter influences the amplitude and the frequency spectrum. Thus, a comprehensive evaluation typically allows not just one but several properties of the precipitation to be determined. This classification therefore allows the type and/or composition of precipitation to be evaluated in detail. The spatial and temporal resolution of precipitation measurements and forecasts can also be improved.

According to embodiments, the panel structures may therefore be susceptible to the formation of oscillation patterns caused by rain and wind, e.g., PV modules or skylights. According to embodiments, a (vibro) acoustic sensor (e.g. as a pressure and/or pressure gradient pickup/receiver) and/or oscillation pickup is used to detect airborne and/or structure-borne sound, which is attached directly to the panel and combined with an intelligent signal analysis algorithm (possibly with machine learning) to determine precipitation time, precipitation amount, wind strength, and other weather characteristics. To improve accuracy, signal analysis can be optionally adapted to local sensors. The system can be expanded in conjunction with additional sensors, e.g. temperature, air pressure, wind speed.

For PV systems and other surfaces, the measuring element can be positioned above (on the side exposed to the precipitation) or below (on the side facing away from the precipitation or protected from precipitation).

With regard to PV modules, it is to be noted that the surface, e.g. the top glass surface of the PV module or the laminated PV module itself, can typically be used as the oscillating surface.

Furthermore, recorded weather data can be used to control other devices, such as closing skylights, regulating and protecting PV systems. In the worst case, severe weather can lead to spontaneous failures during the operation of photovoltaics systems. Permanent weather monitoring reduces the risk for energy networks and network operators.

Technical areas of application for the sensor technology described above are the following:
photovoltaics system/module
Skylights and window panes
Bodywork and window panes of land, air, water, and space vehicles
(industrial) flat roofs, such as corrugated cheap metal roofs
Agricultural irrigation management
Wind turbines

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer. The data carrier, the digital storage medium, or the recorded medium are typically tangible, or non-volatile.

A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Method for integrating at least one measuring element into an existing object or an existing structure so as to provide an acoustic precipitation sensor,
wherein an element is part of the existing object or the existing structure and is arranged such that a precipitation to be captured impacts on the element, wherein the element is configured such that the impacting precipitation generates an acoustic signal, and
wherein the measuring element is arranged with respect to the element to capture the acoustic signal;
wherein a signal processing unit is configured to receive and process a measuring signal generated by the measuring element as a reaction to the acoustic signal so as to determine one or several properties of the precipitation, e.g. in real time, on the basis thereof;
wherein the signal processing unit comprises an analysis algorithm, wherein the analysis algorithm is configured to adapt the evaluation performed by the signal processing unit to one or several environmental conditions and/or to a mounting position of the measuring element with respect to the element.

2. Method according to claim 1, wherein the signal processing unit is configured to determine the one or several properties of the precipitation and/or to classify the precipitation on the basis of the one or several properties of the precipitation through evaluation by means of an algorithm trained by machine learning, performing a comparison of the received measuring signal with respect to one or several signal patters, and/or by comparison of the received measuring signal to one or several signal patterns having assigned thereto the one or several properties of the precipitation; and/or
wherein the evaluation is carried out on a server or in a cloud-based way.

3. Method according to claim 1, wherein the signal processing unit is configured to classify and/or detect the precipitation on the basis of time representations and/or frequency representations or signals, in particular time and/or frequency signals; and/or
wherein the signal processing unit is configured to determine the one or several properties on the basis of one or several patterns of features and/or feature combinations; and/or
wherein the signal processing unit is configured to perform feature extraction, in particular in the form of a time/frequency transformation or a transformation into other predefined features; and/or
wherein the signal processing unit is configured to provide time data as an input for a ML model.

4. Method according to claim 1, wherein the one or several properties originate from a group comprising:
precipitation amount,
precipitation rate,
precipitation type,
drop shape,
drop size, drop size distribution,
drop speed, drop number.

5. Method according to claim 1, wherein the signal processing unit comprises an analysis algorithm, wherein the analysis algorithm is configured to adapt the evaluation to the location of the precipitation sensor.

6. Method according to claim 1, wherein the at least one element comprises part of a body of a vehicle, part of an aircraft or part of an object or building and/or
wherein the at least one element comprises a plate, a disc, a glass pane, a windshield, a dome, a housing surface, an outer wall and/or any other type of oscillation-capable surface; and/or
wherein the element is a photovoltaic module.

7. Method according to claim 1, wherein the measuring element comprises one or several microphones configured to capture a sound signal.

8. Method according to claim 1, wherein a material and/or a geometry and/or a dimension of the element are selected to generate the acoustic signal such that the one or several properties of the precipitation may be determined; and/or
wherein the acoustic signal comprises a characteristic oscillation pattern that is characteristic for the one or several properties of the precipitation.

9. Method according to claim 1, wherein the element is arranged or configured such that impacting precipitation leaves the element; and/or
wherein the element is heatable.

10. Method according to claim 1, wherein the element is configured as follows: dome-shaped, key-shaped, corrugated, in the form of a cavity, in the form of a resonant body, as planar plate; and/or
wherein the element is configured as a liquid surface or surface with a liquid film, or wherein the element is covered with a liquid film.

11. Method according to claim 1, wherein the element and the measuring element are arranged so as to be oscillation-decoupled with respect to each other; and/or
comprising an oscillation decoupling element arranged between the element and the measuring element.

12. Method according to claim 1, comprising an amplification element configured to amplify the acoustic signal generated by the element,
wherein the signal processing unit receives the amplified acoustic signal.

13. Method according to claim 1, wherein the precipitation to be captured comprises the water, in its solid and/or liquid states, released from the atmosphere.

14. Method according to claim 1, comprising a plurality of elements arranged so as to be distributed spatially or locally; and/or
configured to support one or several further devices, in particular to control and to protect a photovoltaics system or a skylight.

15. Method according to claim 1, the acoustic precipitation sensor being continuously active or only at defined times or for predefined durations.

16. Method according to claim 1, wherein the existing object or the existing structure comprises a stationary structure and/or a mobile structure.

17. Method according to claim 1, wherein the integration is carried out as a retrofitting option.

18. System with a plurality of acoustic precipitation sensors arranged so as to be distributed locally, e.g. on different roofs, provided according to the method of claim 1, and
a unit connected to all precipitation sensors and aggregating the local result of the signal processing unit of the precipitation sensors and/or causing an improvement of an analysis algorithm of one or several of the signal processing units of the precipitation sensor.

19. Photovoltaics system with at least one photovoltaics module as the element and an acoustic precipitation sensor provided according to the method of claim 1,
at least one measuring element arranged with respect to the element so as to capture the acoustic signal;
a signal processing unit configured to receive and process a measuring signal generated by the measuring element as a reaction to the acoustic signal so as to determine, e.g. in real time, one or several properties of the precipitation on the basis thereof.

20. Photovoltaics system according to claim 19, wherein the energy for the operation of the measuring element and/or of the signal processing unit is provided by the photovoltaics system.
